(19) United States
(12) Patent Application Publication
(10) Pub. No.: US 2023/0166652 A1
(43) Pub. Date: Jun. 1, 2023

(54) ROAD SURFACE DRAWING APPARATUS FOR VEHICLE

(71) Applicant: TOYOTA JIDOSHA KABUSHIKI KAISHA, Aichi-ken (JP)

(72) Inventors: Fumihiko MOURI, Owariasahi-shi (JP); Kentaro MORI, Nisshin-shi (JP)

(21) Appl. No.: 18/071,638

(22) Filed: Nov. 30, 2022

(30) Foreign Application Priority Data
Dec. 1, 2021 (JP) 2021-195057

(51) Int. Cl. B60Q 1/34

(52) U.S. Cl. CPC B60Q 1/34; B60Q 2400/50

(57) ABSTRACT

A road surface drawing apparatus for a vehicle is provided in which a notice indication is formed from a plurality of partial images, the apparatus includes a light source that draws the partial image, and one or more processors configured to control lighting-on or lighting-off of a plurality of the light sources according to an order of drawing or deletion of the plurality of partial images, and the one or more processors are configured to control, at first, simultaneous drawing of all of the partial images, when the partial images are drawn in a predetermined order.

### CROSS REFERENCE TO RELATED APPLICATION

This application claims priority to Japanese Patent Application No. 2021-195057 filed on Dec. 1, 2021, which is incorporated herein by reference in its entirety including the specification, claims, drawings, and abstract.

### TECHNICAL FIELD

The present disclosure relates to a road surface drawing apparatus for a vehicle which draws, with light, a notice indication of a predetermined shape on a road surface in a direction of travel of a vehicle.

### BACKGROUND

A road surface drawing apparatus for a vehicle is an apparatus which is equipped on a vehicle, and which draws, with light, a notice indication of a predetermined shape on a road surface in a direction of travel of the vehicle. In the road surface drawing apparatus for a vehicle, there may be cases in which a notice indication formed from a plurality of partial images is drawn by illuminating light from each of a plurality of light sources (for example, WO 2021/006217).

In the road surface drawing apparatus for vehicle described in WO 2021/006217, the partial images are drawn in an order from a partial image closest to the vehicle to a partial image farthest away from the vehicle. However, with such a drawing order, time is required until the partial image farthest away from the vehicle is drawn. Because of this, there may be cases, for example, in which a pedestrian crossing a crosswalk cannot quickly notice the notice indication drawn on the road surface.

An advantage of the present disclosure lies in provision of a road surface drawing apparatus for a vehicle which enables a pedestrian to quickly notice the notice indication drawn on the road surface.

### SUMMARY

According to one aspect of the present disclosure, there is provided a road surface drawing apparatus for a vehicle which is equipped on the vehicle and which draws, with light, a notice indication of a predetermined shape on a road surface in a direction of travel of the vehicle, wherein the notice indication is formed from a plurality of partial images, the apparatus comprising: a light source that draws the partial image; and one or more processors configured to control lighting-on or lighting-off of a plurality of the light sources according to an order of drawing or deletion of the plurality of partial images, and the one or more processors are configured to control, at first, simultaneous drawing of all of the partial images, when the partial images are drawn in a predetermined order.

According to another aspect of the present disclosure, desirably, in the road surface drawing apparatus for vehicle, after all of the partial images are drawn simultaneously, the one or more processors are configured to control deletion in an order from the partial image closest to the vehicle to the partial image which is the second farthest away from the vehicle.

According to another aspect of the present disclosure, desirably, in the road surface drawing apparatus for vehicle, after all of the partial images are drawn simultaneously, the one or more processors are configured to control deletion in an order from the partial image which is the second farthest away from the vehicle to the partial image closest to the vehicle.

According to another aspect of the present disclosure, desirably, in the road surface drawing apparatus for vehicle, after all of the partial images are drawn simultaneously, the one or more processors are configured to control deletion of the partial images other than the partial image farthest away from the vehicle, and to control drawing in an order from the partial image closest to the vehicle to the partial image which is the second farthest away from the vehicle.

According to another aspect of the present disclosure, desirably, in the road surface drawing apparatus for vehicle, after all of the partial images are drawn simultaneously, the one or more processors are configured to control deletion of the partial images other than the partial image farthest away from the vehicle, and to control drawing in an order from the partial image which is the second farthest away from the vehicle to the partial image closest to the vehicle.

According to another aspect of the present disclosure, there is provided a road surface drawing apparatus for a vehicle which is equipped on the vehicle and which draws, with light, a notice indication of a predetermined shape on a road surface in a direction of travel of the vehicle, wherein the notice indication is formed from a plurality of partial images, the apparatus comprising: a light source that draws the partial image; and one or more processors configured to control lighting-on or lighting-off of a plurality of the light sources according to an order of drawing or deletion of the plurality of partial images, and the one or more processors are configured to control, at first, drawing of only the partial image drawn at a position farthest away from the vehicle, when the partial images are drawn in a predetermined order.

According to another aspect of the present disclosure, desirably, in the road surface drawing apparatus for vehicle, after only the partial image farthest away from the vehicle is drawn, the one or more processors are configured to control drawing in an order from the partial image closest to the vehicle to the partial image which is the second farthest away from the vehicle.

According to another aspect of the present disclosure, desirably, in the road surface drawing apparatus for vehicle, after only the partial image farthest away from the vehicle is drawn, the one or more processors are configured to control drawing in an order from the partial image which is the second farthest away from the vehicle to the partial image closest to the vehicle.

According to the road surface drawing apparatus for a vehicle according to an aspect of the present disclosure, the pedestrian can quickly notice the notice indication drawn on the road surface.

### BRIEF DESCRIPTION OF DRAWINGS

Embodiment(s) of the present disclosure will be described based on the following figures, wherein:

FIG. 1 is a schematic diagram showing a vehicle having a road surface drawing apparatus for a vehicle according to an embodiment of the present disclosure;

FIG. 2 is a block diagram showing a structure of a road surface drawing apparatus for a vehicle according to an embodiment of the present disclosure;

FIG. 3 is a schematic diagram showing an example of a drawing order;

FIG. 4 is a schematic diagram showing another example of the drawing order;

FIG. 5 is a schematic diagram showing another example of the drawing order;

FIG. 6 is a schematic diagram showing another example of the drawing order;

FIG. 7 is a schematic diagram showing another example of the drawing order; and

FIG. 8 is a schematic diagram showing another example of the drawing order.

### DESCRIPTION OF EMBODIMENTS

An embodiment of the present disclosure will now be described in detail. In the following description, a specific shape, a specific material, a specific direction, a specific numerical value, or the like is merely exemplary for facilitating understanding of the present disclosure, and may be suitably changed according to the usage, objective, specification, or the like.

### [Vehicle]

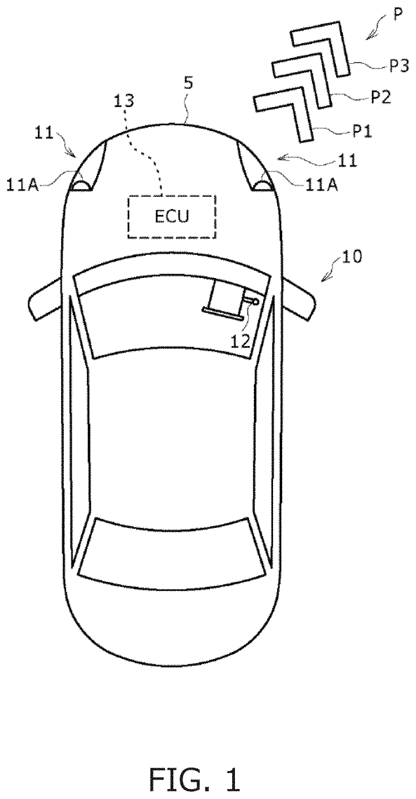

With reference to FIG. 1, a vehicle 5 having a road surface drawing apparatus 10 according to an embodiment of the present disclosure will be described.

The vehicle 5 has the road surface drawing apparatus 10, details of which will be described below. The vehicle 5 is an engine-driven vehicle with four wheels, but is not limited to such a vehicle, and may alternatively be an electricity-driven vehicle or a hybrid electric vehicle.

### [Drawing Apparatus]

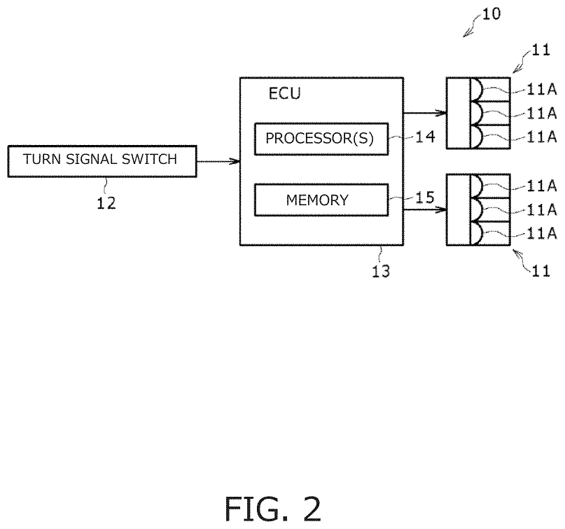

With reference to FIGS. 1 and 2, the road surface drawing apparatus 10 according to an embodiment of the present disclosure will be described.

The road surface drawing apparatus 10 serving as the road surface drawing apparatus for a vehicle is an apparatus which draws, with light, a notice indication P of a predetermined shape on a road surface in a direction of travel of the vehicle 5. The notice indication P is formed from a plurality of partial images Pn, which are drawn in a predetermined order. With the road surface drawing apparatus 10, a pedestrian can quickly notice the notice indication P drawn on the road surface, as will be described below in detail.

As shown in FIG. 1, the road surface drawing apparatus 10 comprises a drawing lamp 11 which is provided at each of a left side and a right side of the vehicle 5 and which has a plurality of light sources 11A which draw the partial images Pn, a turn signal switch 12 for causing the drawing lamp 11 on a side of a direction of travel to draw when the vehicle 5 changes direction, and an ECU (Electronic Control Unit) 13 which controls an order of drawing or deletion of the partial images Pn by the drawing lamp 11.

As described above, the drawing lamp 11 is a signal light which draws the notice indication P formed from a plurality of partial images P1, P2, and P3 on the road surface by radiating a plurality of light rays from the plurality of light sources 11A toward the road surface in the direction of travel of the vehicle 5.

As described above, the drawing lamp 11 is provided at each of the left side and the right side on a front side of the vehicle 5. The arrangement is not limited to such an arrangement, and alternatively, the drawing lamp 11 may be provided at each of the left side and the right side on a rear side of the vehicle 5. Alternatively, the drawing lamp 11 may be provided near a corresponding turn signal lamp (not shown). The turn signal lamp is a signal light which indicates a change of direction of travel of the vehicle 5 by a blinking indication of a lamp on the side of the direction of travel of the vehicle 5.

For the light source 11A, a semiconductor light emitting element is used. The light source 11A is not limited to such a configuration, and alternatively, a light source laser light, a halogen bulb, or an HID (High-Intensity Discharge) lamp may be used as the light source 11A. Alternatively, the drawing lamp 11 may have a lens which projects the light emitted from the light source 11A onto a projection screen and draws an image of the screen on the road surface in the direction of travel, or which draws an image of a predetermined shape on the projection screen on the road surface.

The partial image Pn may have a V-shape having a sharp angle portion directed in the direction of travel of the vehicle 5. Further, the notice indication P may be formed from a plurality of partial images Pn, continuous toward the direction of travel of the vehicle 5. In the following, of the partial images Pn, a partial image closest to the vehicle 5 (drawing lamp 11) will be called a partial image P1, and a partial image farthest away from the vehicle 5 will be called a partial image P3.

As described above, the turn signal switch 12 causes the drawing lamp 11 on the side of the direction of travel to illuminate when the vehicle 5 changes the direction of travel. The turn signal switch 12 is a direction indicator lever provided on the left side or the right side of a steering column. The turn signal switch 12 is a rotatable lever. When the turn signal switch 12 is turned ON by being rotated to the left side, the notice indication P is drawn by the drawing lamp 11 on the left side, and, when the turn signal switch 12 is turned ON by being rotated to the right side, the notice indication P is drawn by the drawing lamp 11 on the right side.

As shown in FIG. 2 and as described above, the ECU 13 controls the order of drawing or deletion of the partial images Pn by controlling the order of lighting-on or lighting-off of the light sources 11A of the drawing lamp 11.

The ECU 13 comprises one or more processors 14 having a CPU, and a memory 15 storing a control program, control data, or the like. The memory 15 is, for example, a RAM, a ROM, a flash memory, or the like. The one or more processors 14 control drawing by each light source 11A of the drawing lamp 11 through an operation according to the order of lighting-on or lighting-off of the light sources 11A stored in the memory 15.

The ECU 13 is connected to the light sources 11A of the drawing lamp 11 and the turn signal switch 12, receives input of an operation signal from the turn signal switch 12, and outputs a control signal to each of the light sources 11A of the drawing lamp 11.

### [Drawing Order]

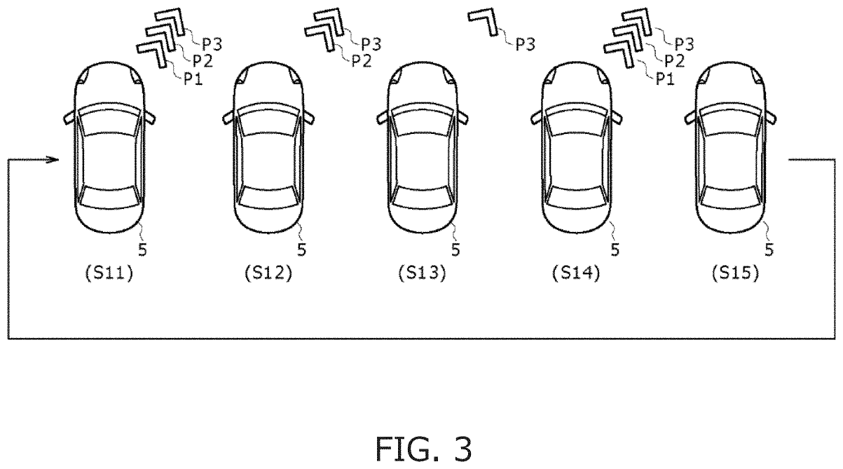

With reference to FIGS. 3 to 8, example drawing orders by the drawing lamp 11 will be described.

In the present embodiment, in all of the drawing orders, when the partial images Pn are drawn in a predetermined order, control is performed so that the farthest-away partial image P3 is drawn first . With this configuration, the pedestrian can quickly notice the partial image P3. In particular, it is possible to enable a pedestrian who wishes to cross a crosswalk in a hurry to quickly notice the partial image P3. In the following, the drawing order when the vehicle turns right will be described, but the drawing order is similar when the vehicle turns left.

First, example configurations will be described in which, as the drawing order, all of the partial images P1, P2, and P3, including the farthest-away partial image P3, are first drawn simultaneously.

In a first example drawing, as shown in step S11 of FIG. 3, the one or more processors 14 control the lighting-on or the lighting-off of the light sources 11A of the drawing lamps 11 so that all of the partial images P1, P2, and P3 are drawn simultaneously, and the partial images are deleted in order from the partial image P1 closest to the vehicle 5.

Specifically, the one or more processors 14 execute the following steps in a repeated manner. First, in step S11, all of the partial images P1, P2, and P3 are drawn simultaneously. Then, in step S12, the partial image P1 closest to the vehicle 5 is deleted, and then, in step S13, the partial image P2 which is the second closest to the vehicle 5 (and the second farthest away from the vehicle 5) is deleted. Then, in step S14, all of the partial images P1, P2, and P3 are again drawn simultaneously. Next, in step S15, all of the partial images P1, P2, and P3 are deleted simultaneously.

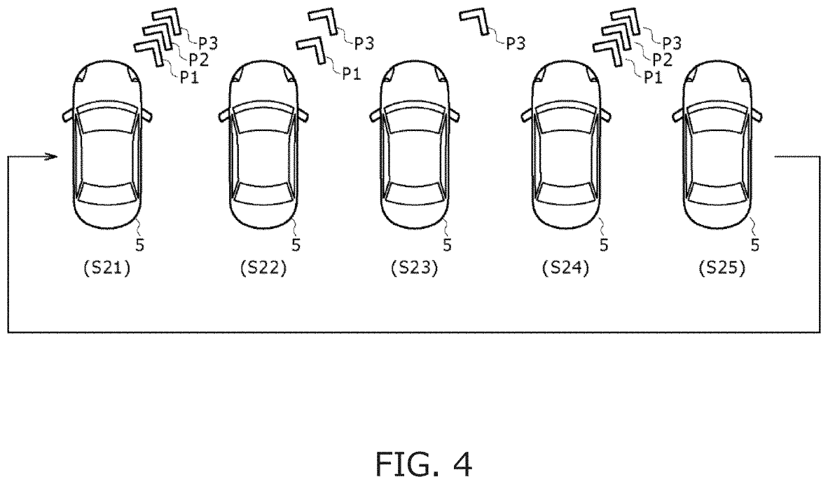

,In a second example drawing, the one or more processors 14 control the lighting-on or the lighting-off of the light sources 11A of the drawing lamp 11 so that all of the partial images P1, P2, and P3 are drawn simultaneously, as shown in step S21 of FIG. 4, and the partial images are deleted in order from the partial image P2 which is the second farthest away from the vehicle 5, as shown in step S22 of FIG. 4.

More specifically, the one or more processors 14 execute the following steps in a repeated manner. First, in step S21, all of the partial images P1, P2, and P3 are drawn simultaneously. Then, in step S22, the partial image P2 which is the second closest to the vehicle 5 (and second farthest away from the vehicle 5) is deleted, and then, in step S23, the partial image P1 closest to the vehicle 5 is deleted. Then, in step S24, all of the partial images P1, P2, and P3 are again drawn simultaneously. Next, in step S25, all of the partial images P1, P2, and P3 are deleted simultaneously.

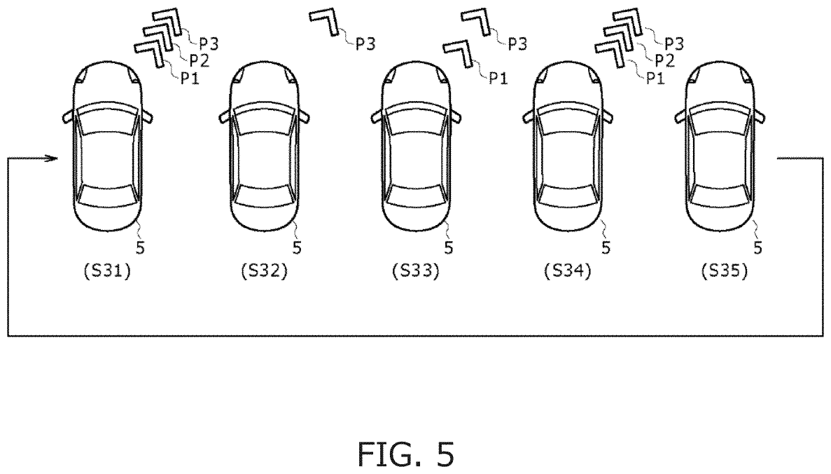

In a third example drawing, as shown in step S31 of FIG. 5, the one or more processors 14 control the lighting-on or the lighting-off of the light sources 11A of the drawing lamp 11 so that all of the partial images P1, P2, and P3 are drawn simultaneously, then, the partial images Pn other than the partial image P3 farthest away from the vehicle 5 are deleted, and subsequently, the partial images are drawn in order from the partial image P1 closest to the vehicle 5.

More specifically, the one or more processors 14 execute the following steps in a repeated manner. First, in step S31, all of the partial images P1, P2, and P3 are drawn simultaneously. Then, in step S32, the partial images P1 and P2 other than the partial image P3 farthest away from the vehicle 5 are deleted, then, in step S33, the partial image P1 closest to the vehicle 5 is drawn, and then, in step S34, the partial image P2 which is the second closest to the vehicle 5 is drawn. Next, in step S35, all of the partial images P1, P2, and P3 are deleted simultaneously.

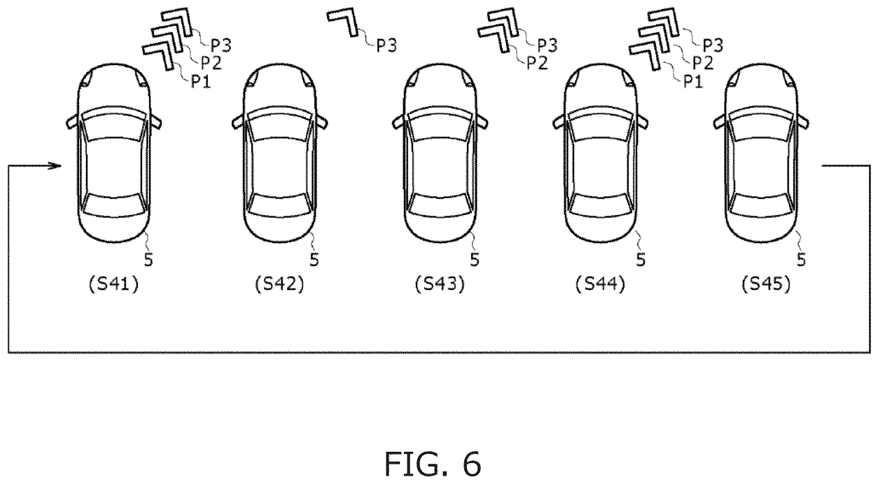

In a fourth example drawing, as shown in FIG. 6, the one or more processors 14 control the lighting-on or the lighting-off of the light sources 11A of the drawing lamp 11 so that all of the partial images P1, P2, and P3 are drawn simultaneously, partial images Pn other than the partial image P3 farthest away from the vehicle 5 are deleted, and the partial images are drawn in order from the partial image P2 which is the second farthest away from the vehicle 5.

More specifically, the one or more processors 14 execute the following steps in a repeated manner. First, in step S41, all of the partial images P1, P2, and P3 are drawn simultaneously. Then, in step S42, the partial images P1 and P2 other than the partial image P3 farthest away from the vehicle 5 are deleted, then, in step S43, the partial image P2 which is the second closest to the vehicle 5 is drawn, and then, in step S44, the partial image P1 closest to the vehicle 5 is drawn. Next, in step S45, all of the partial images P1, P2, and P3 are deleted simultaneously.

Next, example drawing orders will be described in which only the farthest-away partial image P3 is first drawn.

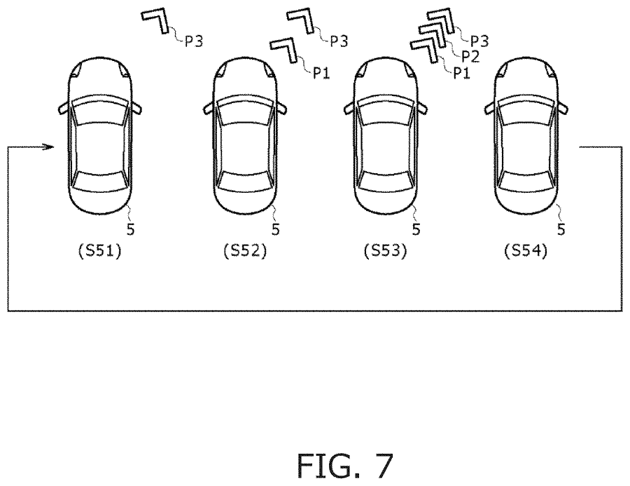

In a fifth example drawing, as shown in FIG. 7, the one or more processors 14 control the lighting-on or the lighting-off of the light sources 11A of the drawing lamp 11 so that only the partial image P3 farthest away from the vehicle 5 is first drawn, and then, the partial images are drawn in order from the partial image P1 closest to the vehicle 5.

More specifically, the one or more processors 14 execute the following steps in a repeated manner. First, in step S51, the partial image P3 farthest away from the vehicle 5 is drawn. Then, in step S52, the partial image P1 closest to the vehicle 5 is drawn. Then, in step S53, the partial image P2 which is the second closest to the vehicle 5 (and the second farthest away from the vehicle 5) is drawn. Next, in step 54, all of the partial images P1, P2, and P3 are deleted simultaneously.

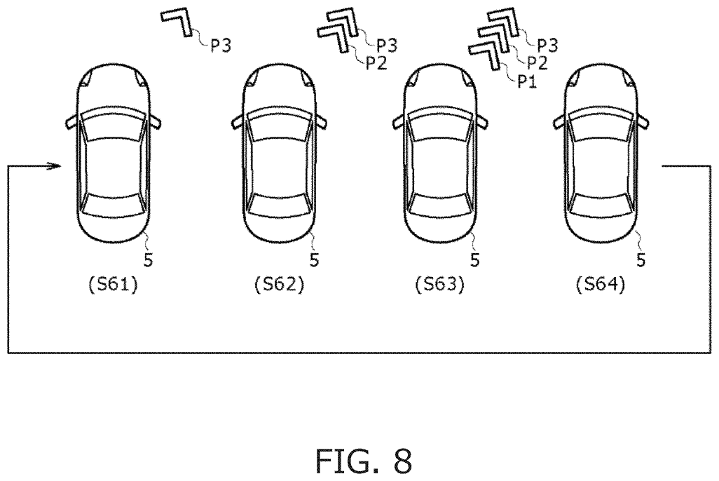

In a sixth example drawing, as shown in FIG. 8, the one or more processors 14 control the lighting-on or the lighting-off of the light sources 11A of the drawing lamp 11 so that only the partial image P3 farthest away from the vehicle 5 is first drawn, and then, the partial images are drawn in order from the partial image P2 which is the second farthest away from the vehicle 5.

More specifically, the one or more processors 14 execute the following steps in a repeated manner. First, in step S61, the partial image P3 farthest away from the vehicle 5 is drawn. Then, in step S62, the partial image P2 which is the second closest to the vehicle 5 (and the second farthest away from the vehicle 5) is drawn. Then, in step S63, the partial image P1 closest to the vehicle 5 is drawn. Next, in step S64, all of the partial images P1, P2, and P3 are deleted simultaneously.

The present disclosure is not limited to the embodiment described above and alternative configurations thereof, and various modifications and improvements are possible within the scope of the present disclosure described in the claims.

For example, the drawing lamp 11 may function as an indication means which indicates an emergency state of the vehicle 5 by drawing a notice indication on the road surface with all of the drawing lamps 11. Alternatively, the drawing lamp 11 may function as an indication means which indicates that the vehicle 5 will move rearwards by drawing a notice indication on a road surface at the rear of the vehicle 5 when the vehicle 5 moves rearwards.

1. A road surface drawing apparatus for a vehicle which is equipped on the vehicle and which draws, with light, a notice indication of a predetermined shape on a road surface in a direction of travel of the vehicle, wherein
the notice indication is formed from a plurality of partial images,
the apparatus comprising:
a light source that draws the partial image; and
one or more processors configured to control lighting-on or lighting-off of a plurality of the light sources according to an order of drawing or deletion of the plurality of partial images, and
the one or more processors are configured to control, at first, simultaneous drawing of all of the partial images, when the partial images are drawn in a predetermined order.

2. The road surface drawing apparatus for vehicle according to claim 1, wherein
after all of the partial images are drawn simultaneously, the one or more processors are configured to control deletion in order from the partial image closest to the vehicle to the partial image which is the second farthest away from the vehicle.

3. The road surface drawing apparatus for vehicle according to claim 1, wherein
after all of the partial images are drawn simultaneously, the one or more processors are configured to control deletion in order from the partial image which is the second farthest away from the vehicle to the partial image closest to the vehicle.

4. The road surface drawing apparatus for vehicle according to claim 1, wherein
after all of the partial images are drawn simultaneously, the one or more processors are configured to control deletion of the partial images other than the partial image farthest away from the vehicle, and to control drawing in order from the partial image closest to the vehicle to the partial image which is the second farthest away from the vehicle.

5. The road surface drawing apparatus for vehicle according to claim 1, wherein
after all of the partial images are drawn simultaneously, the one or more processors are configured to control deletion of the partial images other than the partial image farthest away from the vehicle, and to control drawing in order from the partial image which is the second farthest away from the vehicle to the partial image closest to the vehicle.

6. A road surface drawing apparatus for a vehicle which is equipped on the vehicle and which draws, with light, a notice indication of a predetermined shape on a road surface in a direction of travel of the vehicle, wherein
the notice indication is formed from a plurality of partial images,
the apparatus comprising:
a light source that draws the partial image; and
one or more processors configured to control lighting-on or lighting-off of a plurality of the light sources according to an order of drawing or deletion of the plurality of partial images, and
the one or more processors are configured to control, at first, drawing of only the partial image drawn at a position farthest away from the vehicle, when the partial images are drawn in a predetermined order.

7. The road surface drawing apparatus for vehicle according to claim 6, wherein
after only the partial image farthest away from the vehicle is drawn, the one or more processors are configured to control drawing in order from the partial image closest to the vehicle to the partial image which is the second farthest away from the vehicle.

8. The road surface drawing apparatus for vehicle according to claim 6, wherein
after only the partial image farthest away from the vehicle is drawn, the one or more processors are configured to control drawing in order from the partial image which is the second farthest away from the vehicle to the partial image closest to the vehicle.
